(19) United States
(12) Patent Application Publication
(10) Pub. No.: US 2021/0118464 A1
(43) Pub. Date: Apr. 22, 2021

(54) METHOD AND APPARATUS FOR EMOTION RECOGNITION FROM SPEECH

(71) Applicant: WONDER GROUP TECHNOLOGIES LTD., Beijing (CN)

(72) Inventors: Christopher C. DOSSMAN, Beijing (CN); Biman Najika LIYANAGE, Beijing (CN); Ted Jens Mats OESTREM, Beijing (CN)

(21) Appl. No.: 16/956,158

(22) PCT Filed: Dec. 19, 2017
(86) PCT No.: PCT/CN2017/117286

§ 371 Date: Jun. 19, 2020

(51) Int. Cl. G10L 25/63; G10L 25/24; G10L 25/84; G06K 9/62; G06N 20/00

(52) U.S. Cl. CPC G10L 25/63; G10L 25/24; G10L 2025/783; G06K 9/6256; G06N 20/00; G10L 25/84

(57) ABSTRACT

Embodiments of the present invention relate to a method and apparatus for emotion recognition from speech. According to one embodiment of the invention, a method for emotion recognition from speech may include: receiving an audio signal; performing data cleaning on the received audio signal; slicing the cleaned audio signal into at least one segment; performing feature extraction on the at least one segment to extract a plurality of Mel frequency cepstral coefficients and a plurality of Bark frequency cepstral coefficients from the at least one segment; performing feature padding by padding the plurality of Mel frequency cepstral coefficients and the plurality of Bark frequency cepstral coefficients into a feature matrix based a length threshold; and performing machine learning inference on the feature matrix to recognize the emotion indicated in the audio signal. Embodiments of the present invention can be adaptive to an audio signal in almost any size, and can real time recognizing emotions over the speech.

This application is the U.S. national stage of PCT Application No. PCT/CN2017/117286 filed on Dec. 19, 2017, the entire contents of which are hereby incorporated by reference.

### TECHNICAL FIELD

Embodiments of the present invention are directed to emotion recognition technology, and more specifically relates to methods and apparatus for emotion recognition from speech.

### BACKGROUND

Voice communication between humans is extremely complex and nuanced. It conveys not only information in the form of words, but also information about a person's current state of mind. Emotion recognition or understanding the state of the utterer is important and beneficial for many applications, including games, man-machine interface, virtual agents, etc. Psychologists have researched the area of emotion recognition for many years and have produced many theories. On the other hand, machine learning researchers have also researched this area, and get a consensus that emotion state is encoded in speech.

Most existing speech systems process studio recorded, neural speech effectively, however, their performance is poor in the case of emotional speech. Current state-of-the-art emotion detectors only have an accuracy of around 40-50% at identifying the most dominate emotion from four to five different emotions. Thus, a problem for emotional speech processing is the limited functionality of speech recognition methods and systems. This is due to the difficulty in modeling and characterization of emotions present in speech.

Given the above, improvements on emotion recognition are important and urgent to efficiently and accurately recognizing the emotional state of the utterer.

### BRIEF SUMMARY OF THE INVENTION

One purpose of the present application is to provide a method and apparatus for emotion recognition from speech.

According to one embodiment of the application, a method for emotion recognition from speech may include: receiving an audio signal; performing data cleaning on the received audio signal; slicing the cleaned audio signal into at least one segment; performing feature extraction on the at least one segment to extract a plurality of Mel frequency cepstral coefficients and a plurality of Bark frequency cepstral coefficients from the at least one segment; performing feature padding by padding the plurality of Mel frequency cepstral coefficients and the plurality of Bark frequency cepstral coefficients into a feature matrix based a length threshold; and performing machine learning inference on the feature matrix to recognize the emotion indicated in the audio signal.

In an embodiment of the present application, performing data cleaning on the audio signal may further include at least one of the following: removing noise of the audio signal; removing silence in the beginning and end of the audio signal based on a silence threshold; and removing sound clips in the audio signal shorter than a predefined threshold. The silence threshold may be −50 db. The predefined threshold may be ¼ second. In another embodiment of the present application, performing data cleaning on the received audio signal may further include performing band-pass filtering on the received audio signal to control the frequency of the audio signal to be 100-400 kHz.

According to an embodiment of the present application, performing feature extraction on the at least one segment may further include extracting at least one of speaker's gender, loudness, normalized spectral envelope, power spectrum analyses, perceptual ban width, emotion blocks, and tone-coefficient from the audio signal. The length of the window for extracting the Mel frequency cepstral coefficients and the Bark frequency cepstral coefficients in each of the at least one segment may be sized between 10-500 ms.

In another embodiment of the present application, the length threshold is not less than 1 second. Performing feature padding may further include: determining whether the length of the feature matrix reaches the length threshold; when the length of the feature matrix does not reach the length threshold, calculating the amount of data needs to be added to the feature matrix to reach the length threshold; and based on the calculated data amount, padding features extracted from a following segment into the feature matrix to spread the feature matrix. According to a further embodiment of the present application, when the feature matrix does not reach the length threshold, calculating the amount of data needs to be added to the feature matrix to reach the length threshold; and based on the calculated data amount, reproducing the available features in the feature matrix to spread the feature matrix. Moreover, the method may further include skipping said performing feature padding when the length of the feature matrix reaches the length threshold.

According to an embodiment of the present application, performing machine learning inference on the feature matrix may further include normalizing and scaling the feature matrix. In addition, performing machine learning inference on the feature matrix may further include feeding the feature matrix into a machine learning model. The machine learning model may be a neural network. In another embodiment of the present application, performing machine learning inference on the feature matrix may further include training the machine learning model to perform the machine learning inference. According to an embodiment of the present application, training the machine learning model may include optimizing a plurality of model hyper parameters; selecting a set of model hyper parameters from the optimized model hyper parameters; and measuring the performance of the machine learning model with the selected set of model hyper parameters. Optimizing a plurality of model hyper parameters may further include generating a plurality of hyper parameters; training the learning model on sample data with the plurality of hyper parameters; and finding the best learning model during training the learning model. The model hyper parameters may be model shapes.

In an embodiment of the present application, performing machine learning inference on the feature matrix may further include generating an emotion score for at least one of arousal, temper and valence. The generated emotion scores may be combined.

Another embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

A further embodiment of the present application provides a non-transitory, computer-readable storage medium having computer programmable instructions stored therein. The computer programmable instructions are configured to implement a method for emotion recognition from speech as stated above or other method according to an embodiment of the present application.

Embodiments of the present application can be adaptive to an audio signal in almost any size, and can real time recognizing emotions over the speech. In addition, by training the machine learning models, the embodiments of the present application can keep improving in efficiency and accuracy.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only example embodiments of the present application and are not therefore to be considered to be limiting of its scope.

FIG. 1 is a block diagram illustrating a system for emotion recognition from speech according to an embodiment of the present application;

FIG. 2 is a flow chart illustrating a method for emotion recognition from speech according to an embodiment of the present application;

FIG. 3 is a flow chart illustrating a method for padding features into a feature matrix according to an embodiment of the present application; and

FIG. 4 is a flow chart illustrating a method for training a machine learning model according to an embodiment of the present application.

### DETAILED DESCRIPTION OF THE INVENTION

The detailed description of the appended drawings is intended as a description of the currently preferred embodiments of the present application, and is not intended to represent the only form in which the present application may be practiced. It is to be understood that the same or equivalent functions may be accomplished by different embodiments that are intended to be encompassed within the spirit and scope of the present application.

Speech is a complex signal containing information about message, speaker, language, emotion and so on. Knowledge of utterer's emotion can be useful for many applications including call centers, virtual agents, and other natural user interface. Today's speech system may reach human equivalent performance only when they can process underlying emotions effectively. Purpose of sophisticated speech systems should not be limited to mere message processing, rather they should understand the underlying intentions of the speaker by detecting expressions in speech. Accordingly, emotion recognition from speech has emerged as an important area in the recent past.

According to embodiment of the present application, emotion information may be stored in the form of soundwaves that change over time. A single soundwave may be formed by combining a plurality of different frequencies. Using Fourier transforms, it is possible to turn the single soundwave back into the component frequencies. The information indicated by the component frequencies contains specific frequencies and their relative power compared to each other. Embodiments of the present application can increase the efficiency and accuracy of emotion recognition from speech. At the same time, a method and apparatus for emotion recognition from speech according to embodiments of the present application are robust enough to process real-life and noisy speech to identify emotions.

According to an embodiment of the present application, the basic stages of a method for emotion recognition from speech may be summarized as: receiving an audio signal, performing data cleaning on the received audio signal; slicing the cleaned audio signal into at least one segment; performing feature extraction on the at least one segment to extract a plurality of Mel frequency cepstral coefficients and a plurality of Bark frequency cepstral coefficients from the at least one segment; performing feature padding by padding the plurality of Mel frequency cepstral coefficients and the plurality of Bark frequency cepstral coefficients into a feature matrix in a predefined length; and performing machine learning inference on the feature matrix to recognize the emotion indicated in the audio signal.

More details on the embodiments of the present application will be illustrated in the following text in combination with the appended drawings.

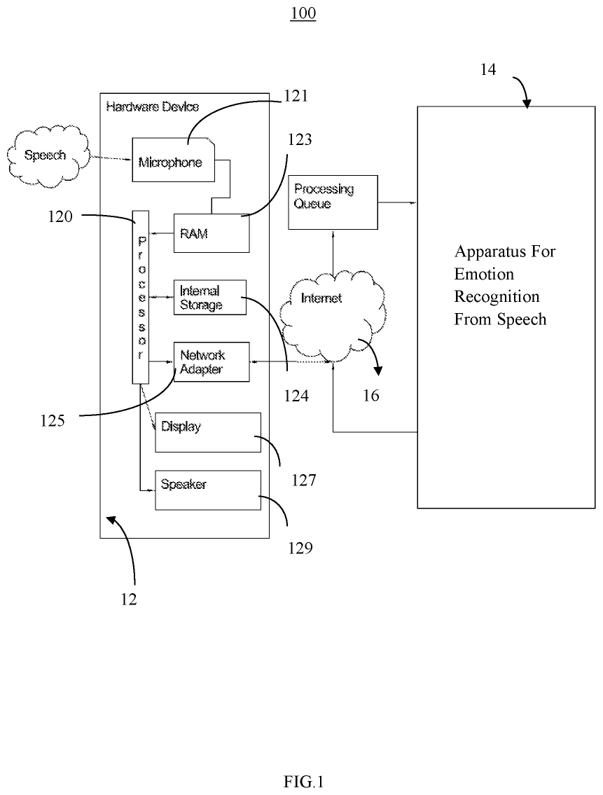

FIG. 1 is a block diagram illustrating a system 100 for emotion recognition from speech according to an embodiment of the present application.

As shown in FIG. 1, the system 100 for emotion recognition from speech may include at least one hardware device 12 for receiving and recoding the speech, and an apparatus 14 for emotion recognition from speech according to an embodiment of the present application. The at least one hardware device 12 and the apparatus 14 for emotion recognition from speech may be connected via the internet 16 or a local network etc. In another embodiment of the present application, the at least one hardware device 12 and the apparatus 14 for emotion recognition from speech may be directly connected via cable or wires etc. The at least one hardware device 12 may be a call center, man-machine interface or virtual agent. In this embodiment of the present application, the at least one hardware device 12 may include a processor 120 and a plurality of peripherals. The plurality of peripherals may include a microphone 121, at least one computer memory or other non-transitory storage medium, for example a RAM (Random Access Memory) 123 and internal storage 124, a network adapter 125, a display 127 and a speaker 129. The speech may be captured with the microphone 121, recorded, digitized, and stored in the RAM 123 as audio signals. The audio signal are transmitted from the at least one hardware device 12 to the apparatus 14 for emotion recognition from speech via the internet 16, wherein the audio signal may be first in a processing queue to wait for be being processed by the apparatus 14 for emotion recognition from speech.

In an embodiment of the present application, the apparatus 14 for emotion recognition from speech may include a processor and a memory. Computer programmable instructions for implementing a method for emotion recognition from speech are stored in the memory and are executable by the processor.

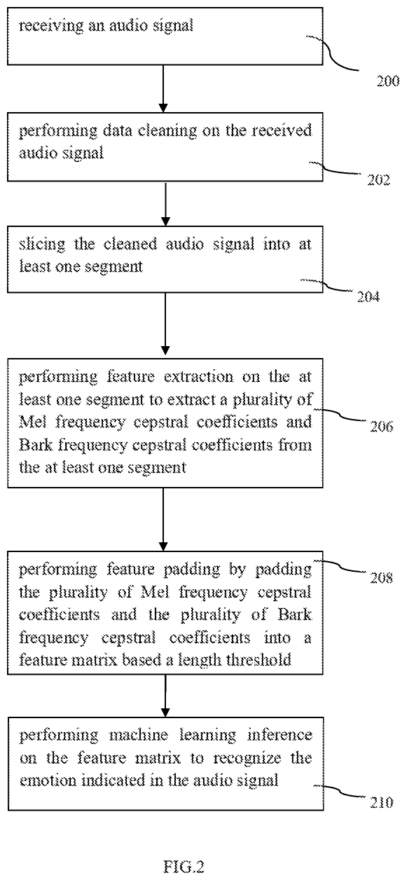

FIG. 2 is a flow chart illustrating a method for emotion recognition from speech according to an embodiment of the present application.

As shown in FIG. 2, the method for emotion recognition from speech may receive an audio signal, for example from the processing queue shown in FIG. 1 in step 200.

In step 202, data cleaning may be performed on the received audio signal. According to an embodiment of the present application, performing data cleaning on the audio signal may further include at least one of the following: removing noise of the audio signal; removing silence in the beginning and end of the audio signal based on a silence threshold; and removing sound clips in the audio signal shorter than a predefined threshold. For example, the method for emotion recognition from speech may include performing band-pass filtering on the received audio signal to control the frequency of the audio signal to be 100-400 kHz so that the high frequency noise and low frequency noise are removed from the audio signal. In an embodiment of the present application, the silence threshold may be −50 db. That is, for a sound clip with a loudness lower than −50 db, it will be regarded as silence and will be removed from the audio signal. According to an embodiment of the present application, the predefined threshold may be ¼ second. That is, for a sound clip with a length shorter than ¼ second, it will be regarded as too short to be remained in the audio signal. Similarly, data cleaning will increase the efficiency and accuracy of the method for emotion recognition from speech.

The cleaned audio signal may be sliced into at least one segment in step 204 according to an embodiment of the present application, and then features are extracted from at least one segment in step 206, which may be achieved through Fast Fourier Transform (FFT).

Extracting suitable features for developing any of a speech is a crucial decision. The features are to be chosen to represent intended information. For persons skilled in the art, there are three important speech features namely: excitation source features, vocal tract system features and prosodic features. According to an embodiment of the present application, Mel frequency cepstral coefficients and Bark frequency cepstral coefficients are extracted from the at least one segment. The length of the window for extracting the Mel frequency cepstral coefficients and the Bark frequency cepstral coefficients in each of the at least one segment may be sized between 10-500 ms. Mel frequency cepstral coefficients and Bark frequency cepstral coefficients both are prosodic features. For example, Mel frequency cepstral coefficients are coefficients that collectively make up an MFC (Mel frequency cepstrum), which is a representation of the short-term power spectrum of sound, based on a linear cosine transform of a log power spectrum on a nonlinear Mel scale of frequency.

In addition to Mel frequency cepstral coefficients and Bark frequency cepstral coefficients, at least another prosodic feature, for example, speaker's gender, loudness, normalized spectral envelope, power spectrum analyses, perceptual ban width, emotion blocks, and tone-coefficient may be extracted from the audio signal to further improve results. In an embodiment of the present application, at least one of the excitation source features and vocal tract system features may also be extracted.

The extracted features are padded in step 208 into a feature matrix based on a length threshold. That is, after padding the extracted features into the feature matrix, whether the length of the feature matrix reaches the length threshold will be determined. When the length of the feature matrix reaches the length threshold, the method for emotion recognition from speech will skip from performing feature padding to the sequent step of the method for emotion recognition from speech. Otherwise, the method for emotion recognition from speech may continue padding features into the feature matrix to spread the feature matrix to reach the length threshold. The length threshold may be not less than 1 second. In an embodiment of the present application, the extracted plurality of Mel frequency cepstral coefficients and Bark frequency cepstral coefficients are padded into a feature matrix based on a length threshold, for example, in one second. Padding feature into a feature matrix based on a length threshold can achieve real-time emotion recognition, and allow monitoring emotions over the course of a normal speech. According to an embodiment of the present application, the length threshold may be any value larger than one second, that is, embodiments of the present application can also handle any sized audio signal larger than 1 second. These advantages are missed in the conventional methods and apparatus for emotion recognition from speech.

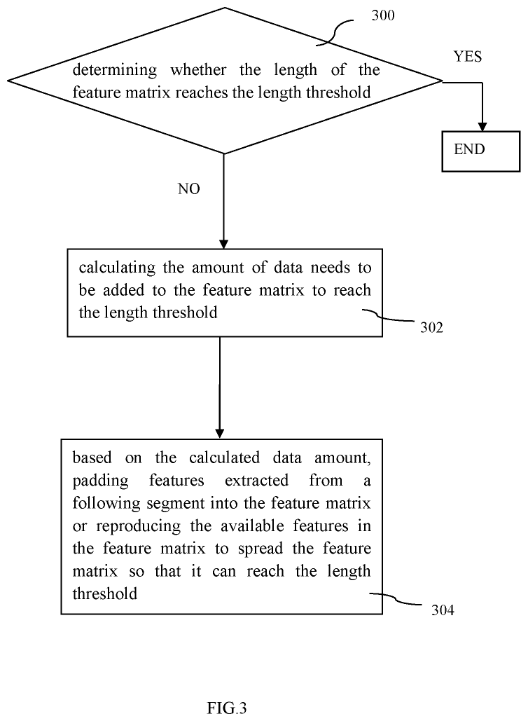

Specifically, FIG. 3 is a flow chart illustrating a method for padding features into a feature matrix according to an embodiment of the present application.

As shown in FIG. 3, according to an embodiment of the application, performing feature padding may further include determining whether the length of the feature matrix reaches the length threshold in step 300. When the length of the feature matrix reaches the length threshold, the method for emotion recognition from speech will skip from performing feature padding to the sequent step, for example step 210 in FIG. 2. When the feature matrix does not reach the length threshold, how much data needs to be added to the feature matrix to reach the length threshold will be calculated in step 302. Based on the calculated data amount, features extracted from a following segment may be padded into the feature matrix together, or reproducing the available features in the feature matrix to spread the feature matrix so that it can reach the length threshold in step 304.

Returning to FIG. 2, in an embodiment of the present application, the method for emotion recognition from speech may further include performing machine learning inference on the feature matrix to recognize the emotion indicated in the audio signal in step 210. Specifically, performing machine learning inference on the feature matrix may further include feeding the feature matrix into a machine learning model. That is, suitable models are to be identified along with features, to capture emotion specific information from the extracted features. In an embodiment of the present application, performing machine learning inference on the feature matrix may further include normalizing and scaling the feature matrix, so that a machine learning model performing the machine learning inference can converge onto a solution. Performing machine learning inference on the feature matrix may further include generating an emotion score for at least one of arousal, temper and valence, and separately outputting scores. The score is in a range of 0-1. In an embodiment of the present application, the generated scores for at least one of arousal, temper and valence respectively may be combined and is output in a single score. Recognizing emotion from speech in arousal, temper, and valence allows the present application to gain more insight of emotion from the audio signal. According to an embodiment of the present application, the three aspects of emotions may be further designed as discrete categories. For example, the temper may be designed as happy, angry and the like. The emotion of the utterer indicated in the speech can be categorized into one of these categories. A soft decision process can also be used where at a given time the utterer's emotion is represented as a mixture of above categories: e.g., one that shows at a certain time how happy a person is, and how sad the person is at the same time etc.

In an embodiment of the present application, the method for emotion recognition from speech may further include training the machine learning model to perform the machine learning inference. The machine learning model may be a neural network or other model training mechanism used to train models and learn mapping between final features and emotion classes, e.g., to find the auditory gist or their combination that correspond to emotion classes such as angry, happy, sad, etc. The training of these models may be done during a separate training operation using input voice signals associated with one or more emotional classes. The resulting trained models may be used during regular operation to recognize emotions from an audio signal by passing auditory gist features obtained from the audio signal through the trained models. The training steps can be repeated again and again so that the machine learning inference on the feature matrix improves over time. More training, more better machine learning models can be achieved.

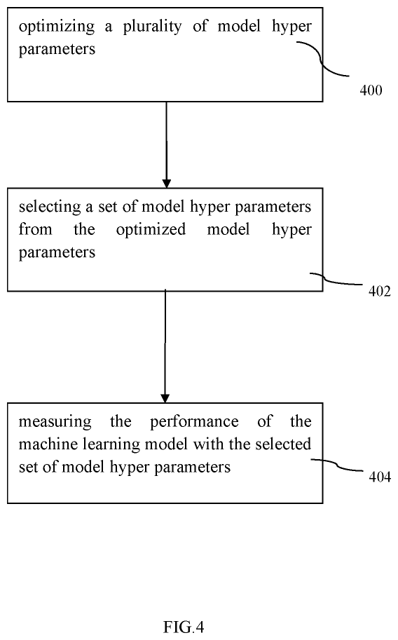

FIG. 4 is a flow chart illustrating a method for training a machine learning model according to an embodiment of the present application.

As shown in FIG. 4, a method for training a machine learning model according to an embodiment of the present application may include optimizing a plurality of model hyper parameters in step 400; selecting a set of model hyper parameters from the optimized model hyper parameters in 402; and measuring the performance of the machine learning model with the selected set of model hyper parameters in step 404. The model hyper parameters may be model shapes.

According to an embodiment of the application, optimizing a plurality of model hyper parameters may further include: generating a plurality of hyper parameters; training the learning model on sample data with the plurality of hyper parameters; and finding the best learning model during training the learning model. By training the machine learning models, embodiments of the present application can greatly improve in efficiency and accuracy.

In an embodiment of the present disclosure, the fore-processing of emotion recognition, such as extracting and padding features etc. can be separately performed from training the machining learning models, and accordingly can be separately performed on different apparatus.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for emotion recognition from speech as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, persons of ordinary skill in the art of the disclosed embodiments would be enabled to make use of the teachings of the present application by simply employing the elements of the independent claims. Accordingly, embodiments of the present application as set forth herein are intended to be illustrative, not limiting. Various changes may be made without departing from the spirit and scope of the present application.

1. A method for emotion recognition from speech, comprising the steps of:
receiving an audio signal;
performing data cleaning on the received audio signal;
slicing the cleaned audio signal into at least one segment;
performing feature extraction on the at least one segment to extract a plurality of Mel frequency cepstral coefficients and a plurality of Bark frequency cepstral coefficients from the at least one segment;
performing feature padding to pad the plurality of Mel frequency cepstral coefficients and the plurality of Bark frequency cepstral coefficients into a feature matrix based a length threshold of the feature matrix; and
performing machine learning inference on the feature matrix to recognize the emotion indicated in the audio signal.

2. A method according to claim 1, wherein said performing data cleaning on the received audio signal further comprises at least one of the following:
removing noise of the audio signal;
removing silence in the beginning and end of the audio signal based on a silence threshold; and
removing sound clips in the audio signal shorter than a predefined threshold.

3. (canceled)

4. (canceled)

5. A method according to claim 1, wherein said performing data cleaning on the received audio signal further comprises performing band-pass filtering on the received audio signal to control the frequency of the audio signal to be 100-400 kHz.

6. (canceled)

7. (canceled)

8. A method according to claim 1, wherein the length threshold is not less than 1 second.

9. A method according to claim 1, wherein said performing feature padding further comprises:
determining whether the length of the feature matrix reaches the length threshold;
when the length of the feature matrix does not reach the length threshold, calculating the amount of data needs to be added to the feature matrix to reach the length threshold; and
based on the calculated data amount, padding features extracted from a following segment into the feature matrix to spread the feature matrix.

10. A method according to claim 1, wherein said performing feature padding further comprises:
determining whether the length of the feature matrix reaches the length threshold;
when the length of the feature matrix does not reach the length threshold, calculating the amount of data needs to be added to the feature matrix to reach the length threshold; and
based on the calculated data amount, reproducing the available features in the feature matrix to spread the feature matrix.

11. (canceled)

12. A method according to claim 1, wherein said performing machine learning inference on the feature matrix further comprises normalizing and scaling the feature matrix.

13. (canceled)

14. (canceled)

15. A method according to claim 1, further comprising training a machine learning model to perform the machine learning inference.

16. A method according to claim 8, wherein said training the machine learning model comprises:
optimizing a plurality of model hyper parameters;
selecting a set of model hyper parameters from the optimized model hyper parameters; and
measuring the performance of the machine learning model with the selected set of model hyper parameters.

17. A method according to claim 9, wherein said optimizing a plurality of model hyper parameters further comprises:
generating the plurality of hyper parameters;
training the machine learning model on sample data with the plurality of hyper parameters; and
finding the best machine learning model during training the machine learning model.

18. A method according to claim 9, wherein the model hyper parameters are model shapes.

19. A method according to claim 1, wherein said performing machine learning inference on the feature matrix further comprises generating an emotion score for at least one of arousal, temper and valence.

20. (canceled)

21. An apparatus for emotion recognition from speech, comprising:
a processor; and
a memory;
wherein computer programmable instructions for implementing a method for emotion recognition from speech are stored in the memory, and the processor is configured to perform the computer programmable instructions to:
receive an audio signal;
perform data cleaning on the received audio signal;
slice the cleaned audio signal into at least one segment;
perform feature extraction on the at least one segment to extract a plurality of Mel frequency cepstral coefficients and a plurality of Bark frequency cepstral coefficients from the at least one segment;
perform feature padding to pad the plurality of Mel frequency cepstral coefficients and the plurality of Bark frequency cepstral coefficients into a feature matrix based on a length threshold of the feature matrix; and
perform machine learning inference on the feature matrix to recognize the emotion indicated in the audio signal.

22. (canceled)

23. (canceled)

24. (canceled)

25. (canceled)

26. (canceled)

27. An apparatus according to claim 13, wherein said performing feature padding further comprises:
determining whether the length of the feature matrix reaches the length threshold;
when the length of the feature matrix does not reach the length threshold, calculating the amount of data needs to be added to the feature matrix to reach the length threshold; and
based on the calculated data amount, padding features extracted from a following segment into the feature matrix to spread the feature matrix.

28. An apparatus according to claim 13, wherein said performing feature padding further comprises:
determining whether the length of the feature matrix reach the length threshold;
when the length of the feature matrix does not reach the length threshold, calculating the amount of data needs to be added to the feature matrix to reach the length threshold; and
based on the calculated data amount, reproducing the available features in the feature matrix to spread the feature matrix.

29. (canceled)

30. (canceled)

31. An apparatus according to claim 13, wherein said performing machine learning inference on the feature matrix further comprises feeding the feature matrix into a machine learning model.

32. An apparatus according to claim 13, further training a machine learning model to perform the machine learning inference.

33. An apparatus according to claim 32, wherein said training the machine learning model comprises:
optimizing a plurality of model hyper parameters;
selecting a set of model hyper parameters from the optimized model hyper parameters; and
measuring the performance of the machine learning model with the selected set of model hyper parameters.

34. (canceled)

35. An apparatus according to claim 13, wherein said performing machine learning inference on the feature matrix further comprises generating an emotion score for at least one of arousal, temper and valence.

36. A non-transitory, computer-readable storage medium having computer programmable instructions stored therein, wherein the computer programmable instructions are programmed to implement a method for emotion recognition from speech according to claim 1 comprising the steps of:
receiving an audio signal;
performing data cleaning on the received audio signal;
slicing the cleaned audio signal into at least one segment
performing feature extraction on the at least one segment to extract a plurality of Mel frequency cepstral coefficients and a plurality of Bark frequency cepstral coefficients from the at least one segment;
performing feature padding to pad the plurality of Mel frequency cepstral coefficients and the plurality of Bark frequency cepstral coefficients into a feature matrix based a length threshold of the feature matrix; and
performing machine learning inference on the feature matrix to recognize the emotion indicated in the audio signal.
